(19) United States
(12) Patent Application Publication
(10) Pub. No.: US 2006/0268360 A1
(43) Pub. Date: Nov. 30, 2006

(54) Methods of creating a virtual window

(76) Inventor: Peter W. J. Jones, Belmont, MA (US)

Correspondence Address: FISH & NEAVE IP GROUP;ROPES & GRAY LLP, ONE INTERNATIONAL PLACE, BOSTON, MA, 02110-2624, US

(21) Appl. No.: 11/433,516

(22) Filed: May 12, 2006

Related U.S. Application Data
(60) Provisional application No. 60/680,121, filed on May 12, 2005.

(51) Int. Cl. H04N 1/40

(52) U.S. Cl. 358/448; 358/474

(57) ABSTRACT

The systems and methods described herein include, among other things, a technique for real time image transmission from a remote sensor head having plural fields of view.

### REFERENCE TO RELATED APPLICATIONS

This Application claims the benefit of U.S. Provisional Application Ser. No. 60/680,121 filed on May 12, 2005. The teachings of the foregoing application are hereby incorporated by reference herein in their entirety.

### BACKGROUND

Today, there are inexpensive sensors that can collect data, including image data, and store that data in a computer readable format. One example of such a sensor is the CCD image sensor. Software programs can then access the stored data and manipulate and process the data to extract useful information.

The low cost of these sensors and the ready availability of computer programs to process data generated from these sensors has led to a host of new applications and devices, including inexpensive video cameras suited to videophone and image capture applications.

One disadvantage of these low cost devices has been the limited field-of-view (FOV) they cover. Given their low cost, engineers have attempted to use multiple sensors to increase the field of view. As each sensor captures a separate field of view, any system that employs multiple sensors, must also have a system that integrates the different fields-of-view together to create one image or one set of data. The data sets are integrated into a single composite data set that can be viewed by the user. In some applications, these sensor systems are placed at a remote location and the captured image data is transmitted, often by wireless transmission, to the user. Although these system can work quite well to capture the image data, there can be an issue when the data set is large, which is common for a high resolution image. Specifically, the transmission rate may be insufficient to transfer the data in real time. As such, the user may not be able to view the scene at a data rate that is sufficient to allow real time observations. In some applications, real time data observation is critical. Some prior art systems, such as that disclosed in U.S. Application Publication No. 2005/0141607, include multiple image sensors which cumulatively provide a panoramic view, wherein the images may be decimated to reduce bandwidth for image transmission. However, some surveillance situations, for example military or law enforcement operations, may additionally require a robust device that can withstand the force of an impact.

Additionally, other prior art systems include very wide angle lens which are corrected by image processing operations. In this way a panoramic view may be created.

There is a need in the art, for improved robust image sensor systems that deliver data at real time data rates to a remote location. Further, there is a need for an efficient and inexpensive system that can allow multiple sensors to work together to provide a composite image presenting an enlarged field-of-view.

### SUMMARY

The invention addresses the deficiencies of the prior art by providing an improved image sensor system. More particularly, in various aspects, the invention provides a technique for real time image transmission from a remote handheld imaging device having plural fields of view.

In one aspect, the invention provides a handheld imaging device including an outer housing, an inner sensor body, a plurality of image sensors disposed on the surface of the sensor body, each image sensor having a field of view and recording an image in each respective field of view, and one or more images being combined into a scene, wherein the scene has a resolution, and a processor for selectively adjusting the resolution of at least a portion of the scene.

In one implementation, the handheld imaging device also includes a transceiver in connection with the processor, for transmitting image data to a remote location. The transceiver may receive image data from the processor, or from a memory.

According to one feature, the plurality of image sensors are positioned such that their fields of view overlap. The plurality of image sensors may be positioned to capture at least a hemispherical region within the fields of view of the plurality of image sensors. In other embodiments, the plurality of image sensors may be positioned to capture a 360-degree view within the fields of view of the plurality of image sensors.

In one configuration, the device may further include a memory containing a table mapping each of a plurality of image points from the scene to a pixel of at least one image sensor. The device may also include a display-driver, wherein the display-driver references the table to determine which pixel from which image sensor to use to display a selected section of the scene.

In one implementation, the plurality of image sensors record an image at a high resolution. The processor may selectively decrease the resolution of the scene captured by the image sensors. Alternatively, the processor may selectively decrease the resolution of a portion of the scene. The processor may selectively adjust the resolution of the scene or a portion of the scene based on a condition. Some possible conditions include movement in the scene and user selection. In one implementation, the processor decreases the resolution of the portion of the scene that is substantially static, and transmits the changing portion of the scene in a higher resolution. In another implementation, a user selects an area of the scene, and the processor decreases the resolution of the unselected portion of the scene. According to another embodiment, the plurality of image sensors record an image at a low resolution.

According to various configurations, the device further includes an image multiplexer for receiving the images recorded by the image sensors. According to one feature, the image multiplexer merges the images and creates a scene. The device may further include a memory for storing the images received by the image multiplexer.

In one configuration, the device includes a memory for storing the images recorded by the sensors.

According to one feature, the outer housing is robust, such that it remains intact upon impact with a hard surface.

In another aspect, the invention provides an imaging device including an outer housing, an inner sensor body, at least one image sensor disposed on the surface of the inner sensor body, the image sensor having a field of view and recording an image in the field of view, wherein the image has a resolution, and a processor for selectively adjusting the resolution of at least a portion of the image.

According to one implementation, the image sensor records an image at a high resolution. The processor may decrease the resolution of the image, or the processor may decrease the resolution of a portion of the image. According to one configuration, the processor selectively decreases the resolution of a portion of the image that is substantially static. According to another configuration, a user selects an area of the image, and the processor decreases the resolution of the unselected portion of the image. The processor may selectively adjust the resolution to allow for real-time transmission of image data.

### BRIEF DESCRIPTION OF THE DRAWINGS

The foregoing and other objects and advantages of the invention will be appreciated more fully from the following further description thereof, with reference to the accompanying drawings wherein;

FIGS. 1 and 2 depict a prior art system for providing a panoramic view;

FIG. 3 depicts a first embodiment of the system according to the invention;

FIG. 4 depicts a graphic scene;

FIG. 5 depicts the graphic scene of FIG. 4 partitioned between two separate fields of view;

FIGS. 6, 7 & 8 depict a system according to the invention with a grid disposed within the field of view;

FIG. 9 depicts a location within an image wherein the location is at the intersection of two separate fields of view;

FIG. 10 depicts a functional block diagram that shows different elements of an intelligent sensor head.

FIGS. 11A-11C depict various embodiments of the system according to the invention.

FIGS. 12A-12G depict graphic scenes with various resolutions.

FIGS. 13A and 13B depict a system according to the invention;

FIG. 14 depicts a user display employing a system according to the invention for depicting a graphic scene, such as the scene depicted in FIG. 4;

FIG. 15 depicts a system according to the invention mounted on a corridor wall detecting a moving object.

FIG. 16A depicts graphically a range of pixels in a lookup table of a system according to the invention with the image of a moving object located therein.

FIG. 16B depicts graphically a range of pixels in a lookup table of a system according to the invention with the image of a moving object located within a view selected therein.

FIG. 16C depicts an image on a display of a system according to the invention.

FIG. 17 depicts graphically an urban war zone where a group of soldiers have deployed a system according to the invention.

FIG. 18 depicts a group of systems according to the invention deployed around a fixed location.

### DETAILED DESCRIPTION OF THE INVENTION

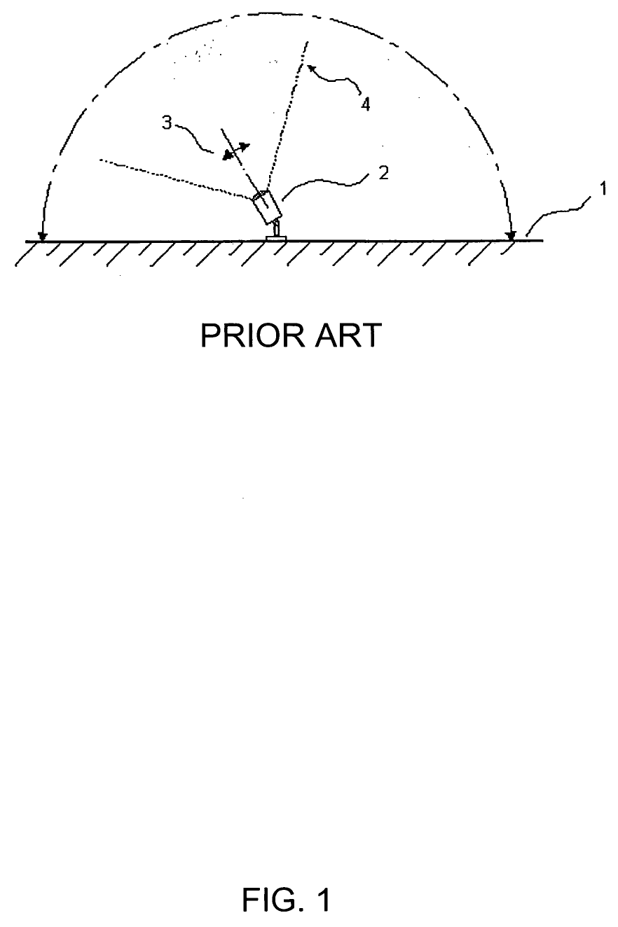

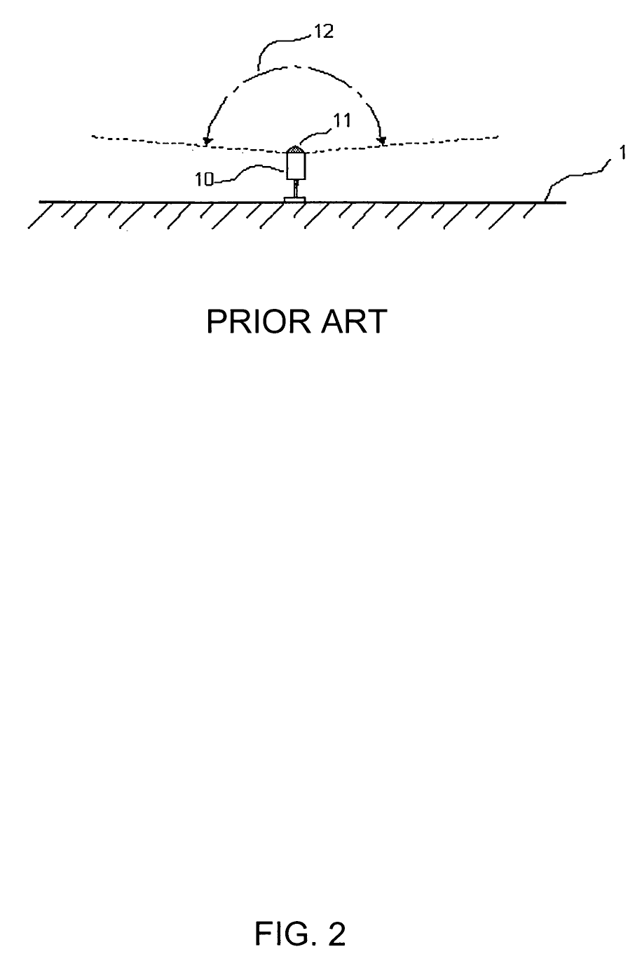

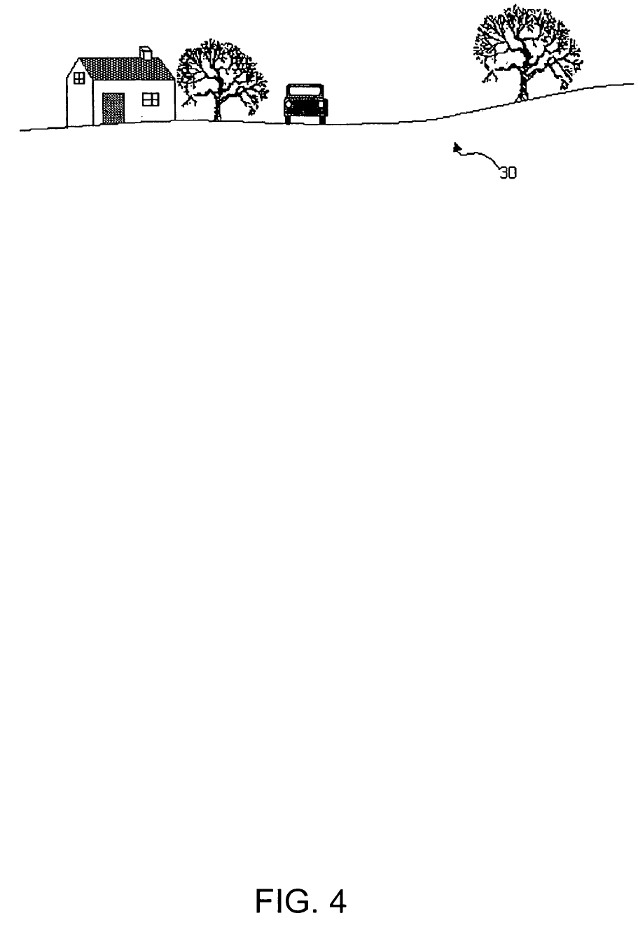

Panoramic views are quite useful and there are numerous existing systems for generating such views. FIGS. 1 and 2 depict a prior art system for providing such a panoramic view. Particularly, FIG. 1 depicts that a sensor 2 capable of collecting an image may be mounted on to a mechanical pivot and moved through an arc 3, 4 to generate a panoramic view of a scene, such as the scene depicted in FIG. 4. FIG. 2 depicts a non-moving sensor including a fisheye lens. A fisheye lens is typically fairly expensive.

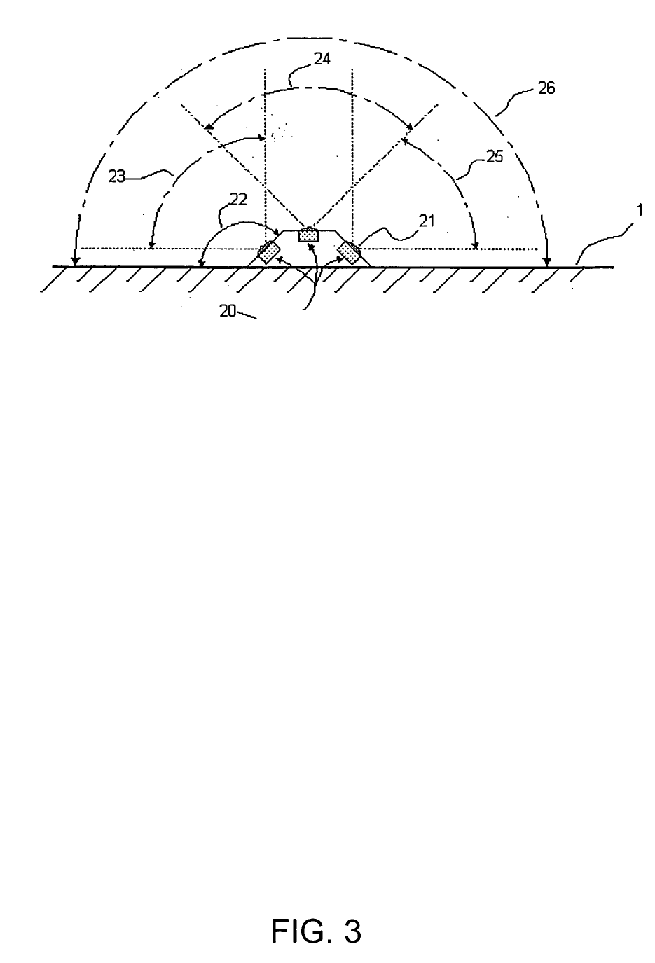

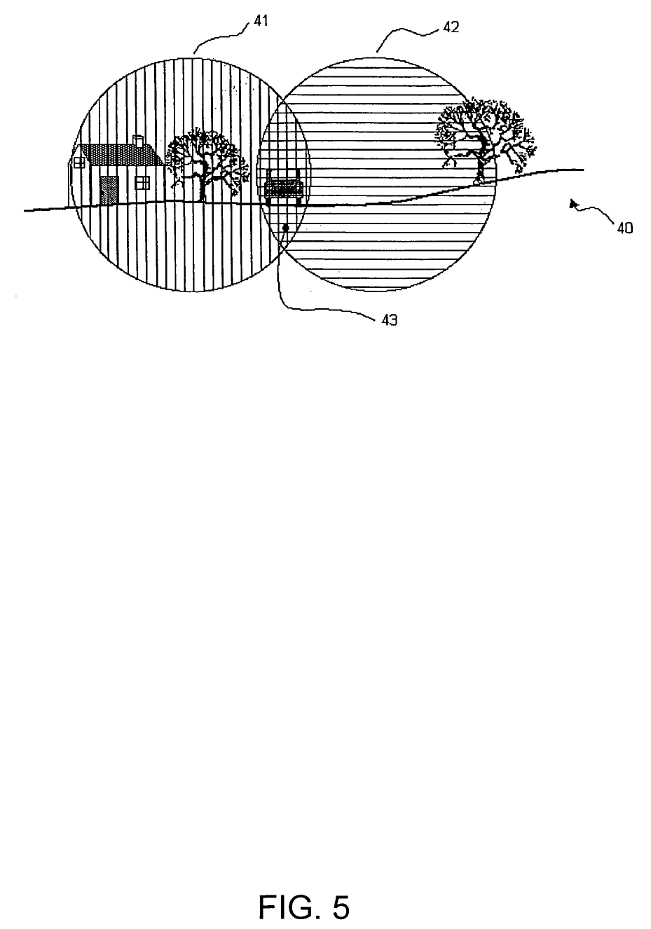

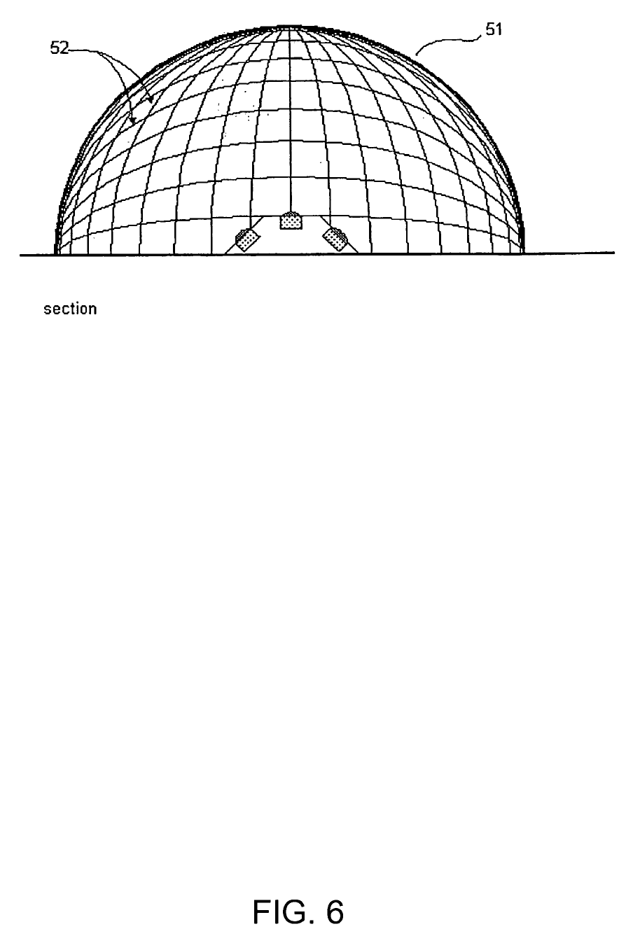

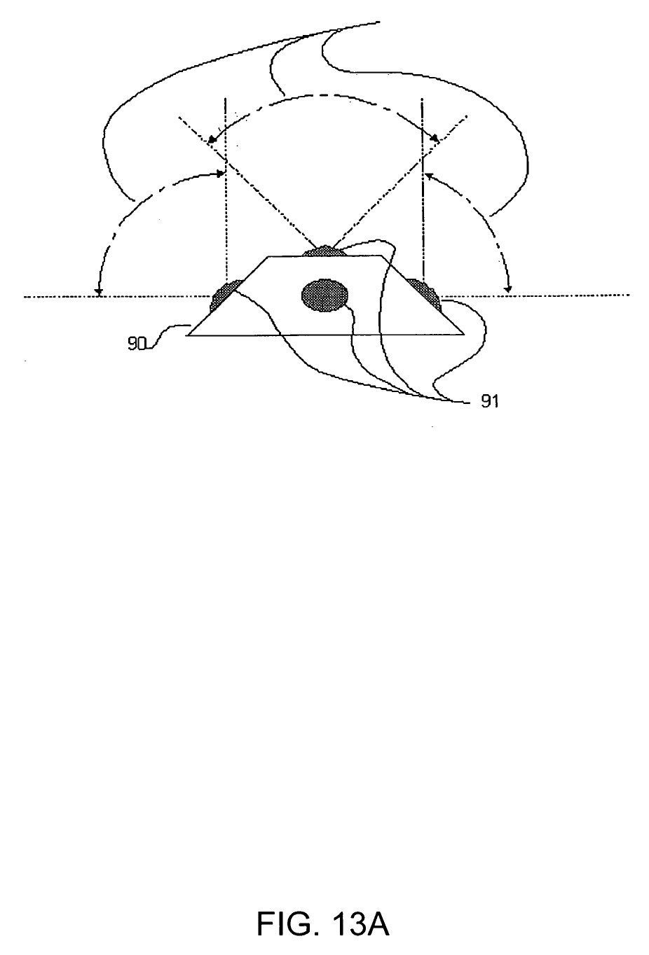

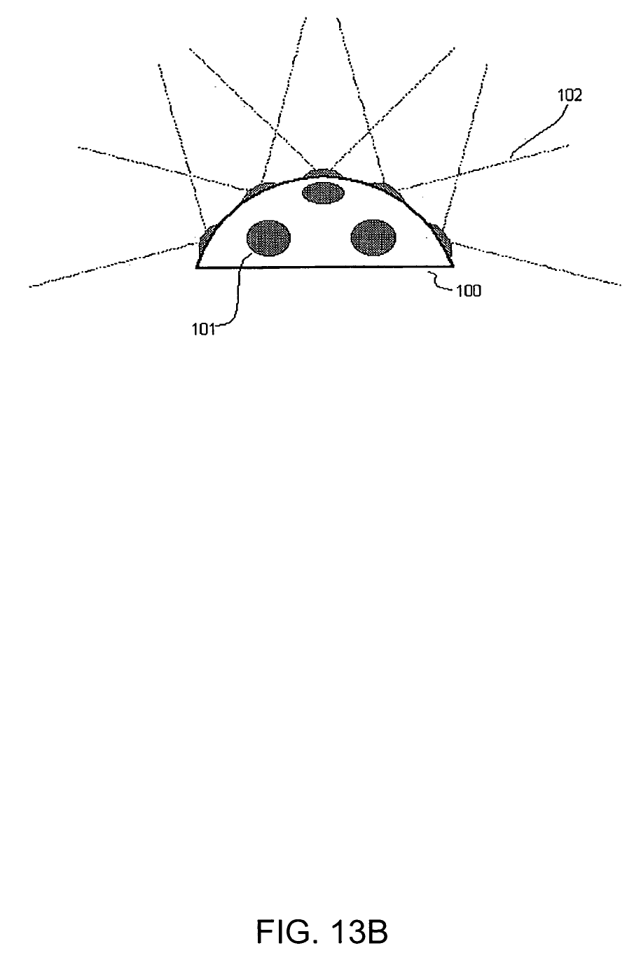

FIG. 3 depicts one embodiment of the systems and methods described herein where a plurality of sensors 21 are statically mounted to a body, where each sensor 21 is directed to a portion of the panoramic scene, as depicted in FIG. 5, and in FIG. 13B. In the depicted embodiment, multiple sensors 21 are mounted on a block so that their individual fields of view 23, 24, 25 overlap and in sum cover a whole hemisphere 26. The block is placed inside a hemispheric dome 51 as depicted in FIG. 6, and in one embodiment a laser beam is played over the inner surface of the dome in such a way that it traces out a grid-like pattern 52. The laser's driver is coordinated with a computer so that when, for example, the laser's spot is directly overhead the sensor block, the computer fills in a lookup table with the information of which pixel of which sensor “sees” the laser spot at that point.

As the laser beam moves around the inside of the dome 51, the lookup table is built up so that for every spot on the dome, the table says which pixels of which sensor “see” it. This lookup table may then be burned into a memory device that resides with the sensor block. In this way, the sensors can be-mounted in a low-precision/low-cost manner, and then given a high precision calibration. The calibration method, being software rather than hardware, is low cost.

Note that the laser dot can be made to cover essentially every spot within the dome (given the diameter of the laser dot and enough time), which means that the lookup table may be filled in by direct correlation of every pixel in the dome's interior to one or more pixels in one or mote sensors. Alternatively, the laser can be made to trace out a more open grid or other pattern and the correlation's between these grid points can be interpolated by the computer.

When the user wants to view a section of the hemispheric view of the sensors that is (for example) 40.degree. wide by 20.degree. high at a certain azimuth and elevation, this request is input into the computer. The computer calculates where the upper left corner of the rectangle of this view lies in the look-up table. The display-driver then looks up which pixel from which sensor to use as it paints the display screen from left to right and top to bottom.

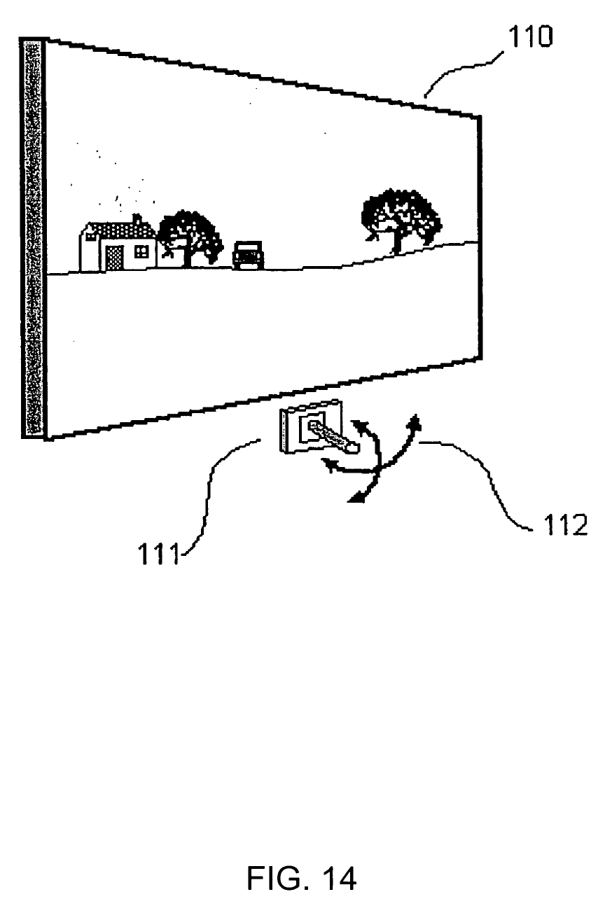

As the user moves his field of view around, the display driver shifts the starting point within the lookup table from which to gather the information to paint the display. This is illustrated FIG. 14 that depicts a user moving through a graphic scene, such as the scene 30 depicted in FIG. 4. According to one feature, the view in the display 110 of FIG. 14 may be moved around using the user control device 111. The user control device 111 may be used to shift the view in the display 110 in any selected direction.

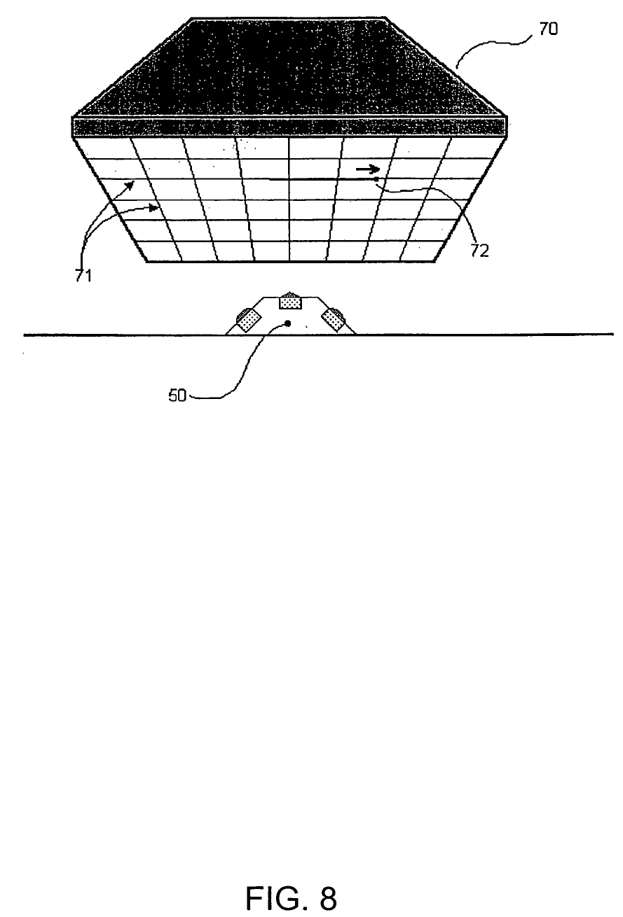

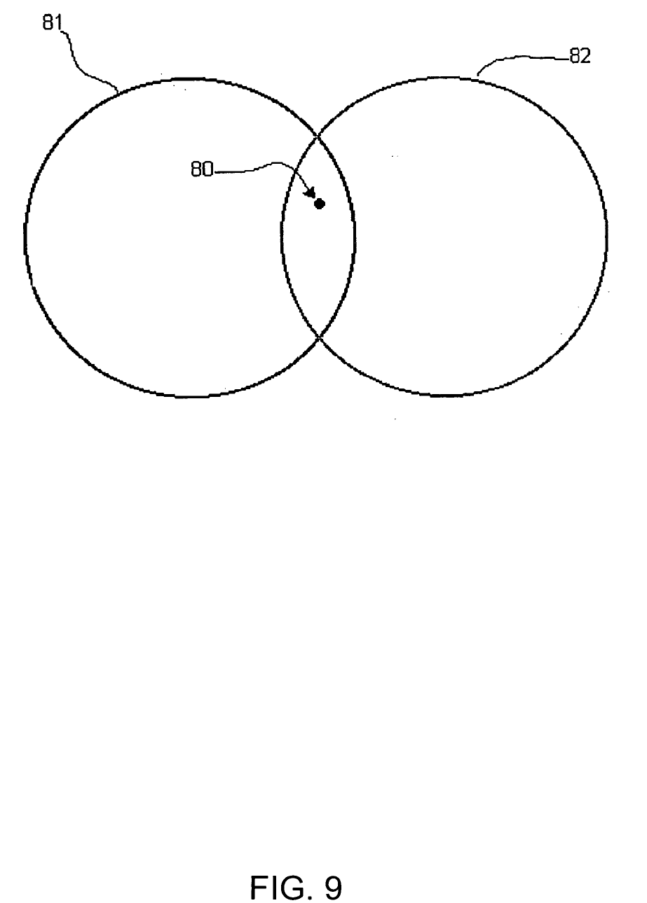

If there are multiple pixels at a certain calibration point (as will happen where the sensors' fields overlap as shown in FIG. 9), then the computer can use a number of different strategies to chose how to write the display. It can:
randomly chose one pixel;
average the values of all the pixels available at that point;
throw out the darkest pixel and display the lighter (if pixels failure mode is off);
use the pixel that has shown the most recent change (another way of detecting broken pixels or pixels whose view has been obscured by dirt on the lens or other kind of damage, i.e., this constitutes a self-healing mechanism); or
apply any other suitable technique for selecting or combining the multiple choices.

If the user wants to “zoom in” on the image, the driver can select a narrower and shorter section of the lookup table's grid to display. If the number of pixels in this lookup table section are fewer than the number of pixels that are needed to paint the full width of the screen then the pixels in between can be calculated, as is common in the “digital zoom” of existing cameras or in programs such as Photoshop.

If the user wants to “zoom out” to get a wider field of view, so that the pixels in the lookup table exceed the pixels in the width and height of the screen, then the computer can average the excess pixels to get an average value to be painted at each pixel displayed on the screen.

Sensors of multiple frequency sensitivity (for example visible light sensors and thermal sensors) can be mixed in a layered lookup table. This would allow the user to select between different kinds of vision, or to merge the different pixel values to get a sensor fusion effect (this can have certain advantages in the military environment for target recognition and identification). The sensors can be of any suitable type and may include CCD image sensors. The sensors may generate a file in any format, such as the raw data, GIF, JPEG, TIFF, PBM, PGM, PPM, EPSF, X11 bitmap, Utah Raster Toolkit RLE, PDS/VICAR, Sun Rasterfile, BMP, PCX, PNG, IRIS RGB, XPM, Targa, XWD, possibly PostScript, and PM formats on workstations and terminals running the X11 Window System or any image file suitable for import into the data processing system. Additionally, the system may be employed for generating video images, including digital video images in the AVI, MPG formats.

Optionally, the system may comprise a micro-controller embedded into the system. The micro-controller may comprise any of the commercially available micro-controllers including the 8051 and 6811 class controllers. The micro-controllers can execute programs for implementing the image processing functions and the calibration functions, as well as for controlling the individual system, such as image capture operations. Optionally, the micro-controllers can include signal processing functionality for performing the image processing, including image filtering, enhancement and for combining multiple fields of view. These systems can include any of the digital signal processors (DSP) capable of implementing the image processing functions described herein, such as the DSP based on the TMS320 core sold and manufactured by the Texas Instruments Company of Austin, Tex.

Optionally, if it is desired or necessary to reduce the bandwidth between the system's sensor head and display, then the digital storage of the lookup table and an associated processor can be placed in the sensor head, making an “intelligent sensor head.” In this way, when the user calls for a certain frame of view within the lookup table's pixels, and the sensor head has to only transmit that specific information, rather than the larger data set that comprises the sensor head's whole field of view. This configuration might be desirable, for example, when using a wireless connection between the sensor head and the display. Besides a wireless connection, the sensor head might alternatively communicate with the display unit by means of a wire, a fiber optic link or via light (for example by means of an Infrared emitter/detector pair).

Also, the system can be configured such that the “intelligent sensor head” will only transmit an image to the system's display if there are certain changes in the pixels in a section of the sensor head's field of view (i.e., movement). In one method the processor that manages lookup table can detect motion, for example, by being programmed to note if a certain number of pixels within the field of view are changing more than a certain set amount while other pixels around these changing pixels are not changing. The “intelligent sensor head” could then select a frame of view such that these changing pixels (the moving object) are centered within the frame and then send that image to the display. Alternatively, the sensor head could select a frame from among a predetermined set of view frames that best contains the changing pixels and send that frame to the display (this may help a user familiar with the set of possible frames more easily identify where within the larger field of view the motion is occurring).

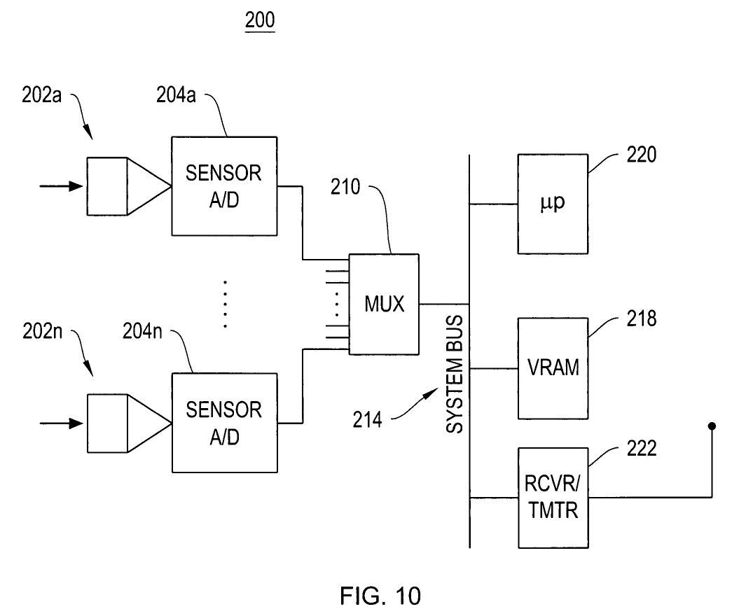

FIGS. 10 through 12G depict in more detail one particular embodiment of an intelligent sensor head, and in particular, depict a sensor head that has sufficient intelligence to provide an image that has multiple sections wherein different sections have different levels of resolution. As will be discussed below, such an intelligent sensor head achieves a type of data compression that allows for a substantial volume of data, which is typical in an imaging application such as this, to be captured and transferred in real time to a remote location.

Turning to FIG. 10, a functional block diagram 200 is presented that shows different elements of an intelligent sensor head capable of compressing the data by selectively choosing a portion of an image to send as a high resolution image, and sending the remaining portion as a low resolution image. In particular, FIG. 10 shows a plurality of lenses 202a-202n that focus an image onto a sensor array, including sensors 204a-204n. The depicted lenses 202a-202n may be arranged on the exterior surface of a sensor head, similar to the way the lenses appear in FIG. 3. The sensor array may be a CCD array of the type commonly used in the industry for generating a digital signal representative of an image. The CCD can have a digital output that can be fed into the depicted multiplexer 210. The depicted multiplexer 210 receives data signals from a plurality of sensors 204a-204n from a CCD array, wherein each signal received by the multiplexer 210 may comprise a high resolution image that makes up a section of the total image being captured by the device. In an alternative embodiment, the signals sent to the multiplexer 210 may comprise a low resolution image that makes up a section of the total image being captures by the device. This image data may be transferred by the multiplexer 210 across the system bus 214 to a video memory 218 located on the system bus 214 and, in one embodiment, capable of storing a high resolution image of the data captured through the sensors 204a-204n.

In one embodiment, a microprocessor 220 or a digital signal processor can access the data in the video memory 218 and feed the data to the receiver/transmitter 222 to be transmitted to a remote location. The receiver/transmitter 222 may include a transceiver for transmitting the data. In this embodiment, each particular sensor 204a-204n stores its field-of-view (FOV) data in the video memory 218 in a range of memory addresses that are associated with that respective sensor. In this way, the data stored in the video memory may be associated, at least logically, with a particular sensor and related FOV, and therefore a particular section of the image being captured by the intelligent sensor head. In one operation, the microprocessor 220 accesses the image data stored in the memory 218 and transmits that data through the transmitter 222 to a remote location. The microprocessor 220 can adjust the resolution of the data as it is read from the image memory 218 and may reduce the resolution of each section of the image being transferred except for a selected section that may be transferred at a high resolution.

In one embodiment, the data stored in the image data is 16 bit data associated with a 1,024×1,024 pixel CCD array sensor. In operation, the microprocessor 220 may choose to transfer only a subportion of the 1,024×1,024 range of pixel data and may also choose to do it at a reduced bit size such as 4 bits. The subportion selected to transfer may be chosen by selecting a reduced subset of the data that will give a lower resolution image for the associated FOV. The subportion may be selected by sub-sampling the data stored in the video memory 218 by, for example, taking every fourth pixel value. In this way, a substantial amount of data compression is achieved by having the majority of the image being transferred at a low resolution.

In an alternative embodiment, the microprocessor 220 may have control lines that connect to the sensors 204a-204n. The control lines can allow the microprocessor 220 to control the resolution of the individual sensor 204a-204n, or the resolution of the image data generated by the sensor 204a-204n. In this alternate embodiment, the microprocessor 220 may respond to a control signal sent from the remote user. The receiver/transmitter 222 depicted in FIG. 10 may receive the control signal and it may pass across the system bus 214 to the microprocessor 220. The control signal directs the microprocessor 220 to select the resolutions of the different sensors 204a-204n, so that one or more of the sensors 204a-204n generates data at one level of resolution, and others generate data at a different level of resolution.

According to another embodiment, the intelligent sensor head may comprise only one sensor 204a. The microprocessor 220 may have control lines that connect to the sensor 204a, and the control lines can allow the microprocessor 220 to control the resolution of the sensor 204a, or the resolution of the image data generated by the sensor 204a. In this alternate embodiment, the microprocessor 220 may respond to a control signal sent from the remote user. According to one feature, the microprocessor 220 may adjust the resolution of a portion of the image data generated by the sensor 204a. For example, the sensor 204a may be able to record high resolution images, and the microprocessor 220 may decrease the resolution of all but a selected portion of the recorded image. The receiver/transmitter 222 depicted in FIG. 10 may receive the control signal and it may pass across the system bus 214 to the microprocessor 220. The control signal directs the microprocessor 220 to select the resolutions of the different portion of an image recorded by the sensor 204a, so that the sensor 204a generates one or more portions of the image at one level of resolution, and other portions at a different level of resolution.

In the embodiments described above, the sensor head is discussed as being able to transmit data at a high or a low level of resolution. However, it will be apparent to those of skill in the art, that the resolution level may be varied as required or allowed by the application at hand, and that multiple resolution levels may employed without departing from the scope of the invention. Further, the number of FOVs that are sent at a high level of resolution may be varied as well. These and other variations are all to be understood as encompassed within the embodiment depicted in FIG. 10.

According to one embodiment, the high-resolution image data has a resolution of greater than about 150 pixels per inch. The resolution may be about 150, about 300, about 500, about 750, about 1000, about 1250, about 1500, about 1750, about 2000, or about 2500 pixels per inch. In some embodiments, the low-resolution image data has a resolution of less than about 150 pixels per inch. The resolution may be about 5, about 10, about 20, about 30, about 40, about 50, about 75, about 100, about 125, or about 150 pixels per inch.

According to some embodiments, the image data has a resolution that is sufficient for situational awareness. According to one feature, situational awareness is awareness of the general objects in the image. A viewer may have situational awareness of objects in an image without being able to discern details of those objects. For example, a viewer may be able to determine that an object in the image is a building, without being able to identify the windows of the building, or a viewer may be able to determine that an object is a car, without being able to determine the type of car. According to another example, a viewer may be able to determine that an object is a person, without being able to identify characteristics of the person, such as the person's gender or facial features. Thus, if a viewer has situational awareness of the scene presented in an image, the viewer has a general understanding of what the scene depicts without being able to distinguish details of the scene. Additionally, a viewer having situational awareness of a scene can detect movement of objects in the scene.

According to other embodiments, situational awareness involves perceiving critical factors in the environment or scene. Situational awareness may include the ability to identify, process, and comprehend the critical elements of information about what is happening in the scene, and comprehending what is occurring as the scene changes, or as objects in the scene move.

Data compression may be accomplished using any suitable technique. For example, data generated by a sensor may be resampled via logarithmic mapping tables to reduce the image pixel count. A resampling geometry which is a rotationally symmetric pattern having cells that increase in size and hence decrease in resolution continuously with distance from the center of the image may be used. Spiral sampling techniques may also be used. The sampling pattern may be spread panoramically across the view fields of all three of the sensors, except for the sensor (or sensors) that will provide the high resolution data. The position having the highest resolution may be selected by the operator as described below. Color data compression may also be applied.

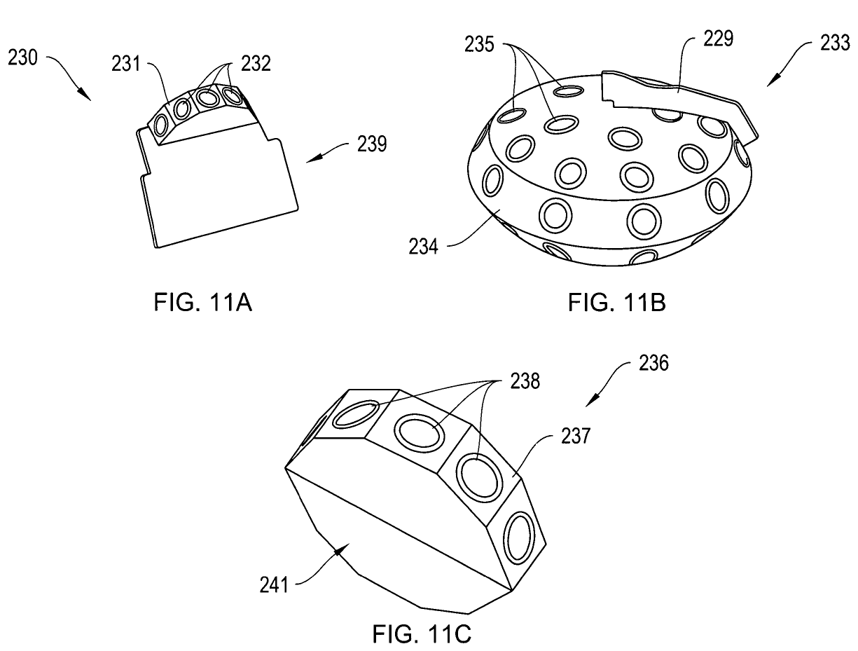

FIGS. 11A-11C depict various embodiments of an intelligent sensor head formed as a part of a handheld device 230, 233, or 236 that has a robust outer housing 231, 234, or 237, respectively. The robust outer housing 231, 234, or 237 allows the device 230, 233, or 236 to be tossed by a user so that it lands on the ground or at a remote location. The housing 231, 234, or 237 may be small enough to be handheld, made from plastic such as poly-propolene, or PMMA and will be lightweight. The devices 230, 233, and 236 include a plurality of lenses 232, 235, and 238. The lenses 234, 235, and 238 may be plastic Fresnel lenses, located in apertures formed in the housings 231, 234, and 237. According to alternative embodiments, the lenses 234, 235, and 238 may be any suitable type of lens, including, for example, standard lenses, wide-angle lenses, and fish-eye lenses. The housings 231, 234, and 237 may be robust, such that they may withstand an impact force of about 10,000 Newtons. In various embodiments, the housings 231, 234, and 237 may be designed to withstand an impact force of about 250 N, about 500 N, about 1000 N, about 2500 N, about 5000 N, about 7500 N, about 15000 N, about 25000 N, 50000 N, or about 100000 N. An activation switch may be pressed that directs the device 230, 233, or 236 to begin taking pictures as soon as it lands and becomes stable. In practice, a law enforcement agent or a soldier could toss the sensor device 230, 233, or 236 into a remote location or over a wall. The sensor head may then generate images of the scene within the room or behind the wall and these images may be transferred back to a handheld receiver/display unit carried by the agent or soldier.

More particularly, FIG. 11A shows the device 230, which includes a circular or polygonal head portion and a tabbed portion 239 extending in a plane that is substantially perpendicular to the plane of the head portion. The head portion includes the lenses 232. According to one feature, tabbed portion 239 provides stability to the device 230 after it lands.

FIG. 11B shows the device 233. The device 233 is substantially elliptically-sphere-shaped with tapered edges. According to one feature, the lenses 235 cover a substantial portion of all of the surfaces of the outer housing 234. The device 233 further includes a wiper 229 positioned substantially perpendicular to a top surface of the device 233. According to one feature, the wiper 229 may rotate around the device 233 and clean water or dirt off the lenses 235.

FIG. 11C shows the device 236. The device 236 is a polygonal prism, with a cross-section having ten sides. According to one feature, the width of the device is greater than the height of the device. In other embodiments, the device 236 may have any suitable number of sides, or it may be substantially cylindrical. The device 236 includes lenses 238, which may be located on the lateral sides of the device 236.

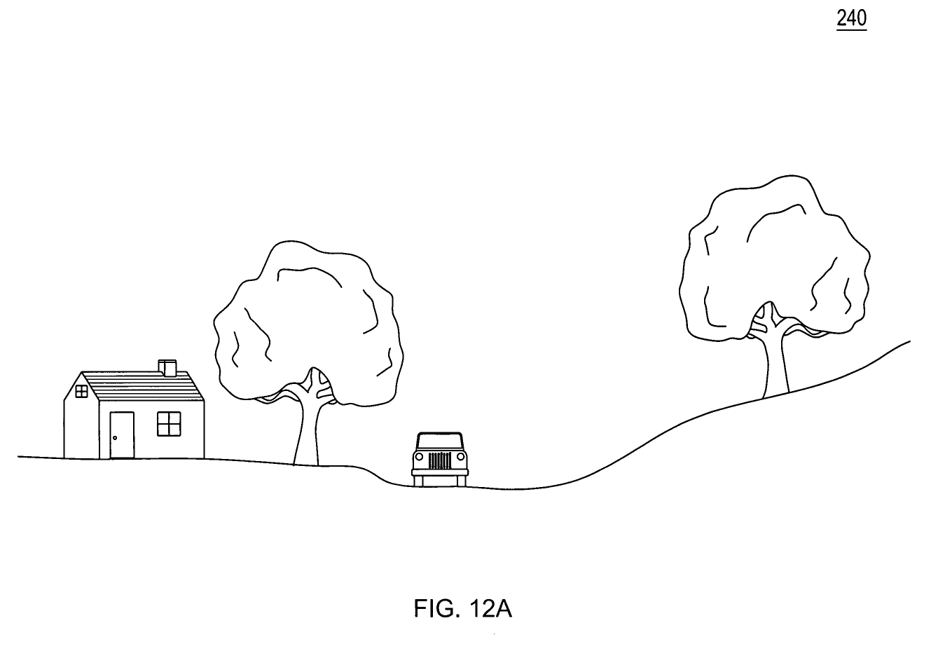

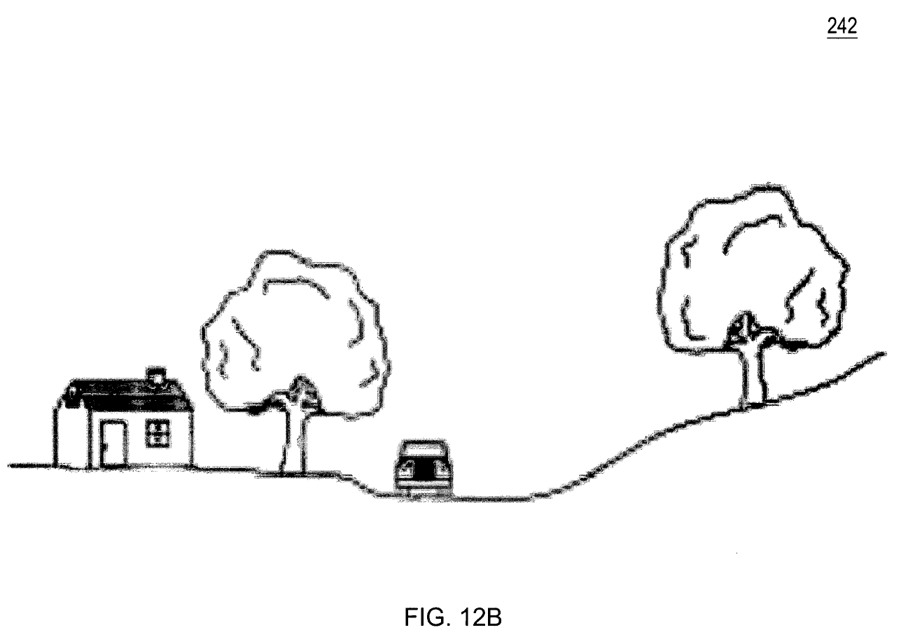

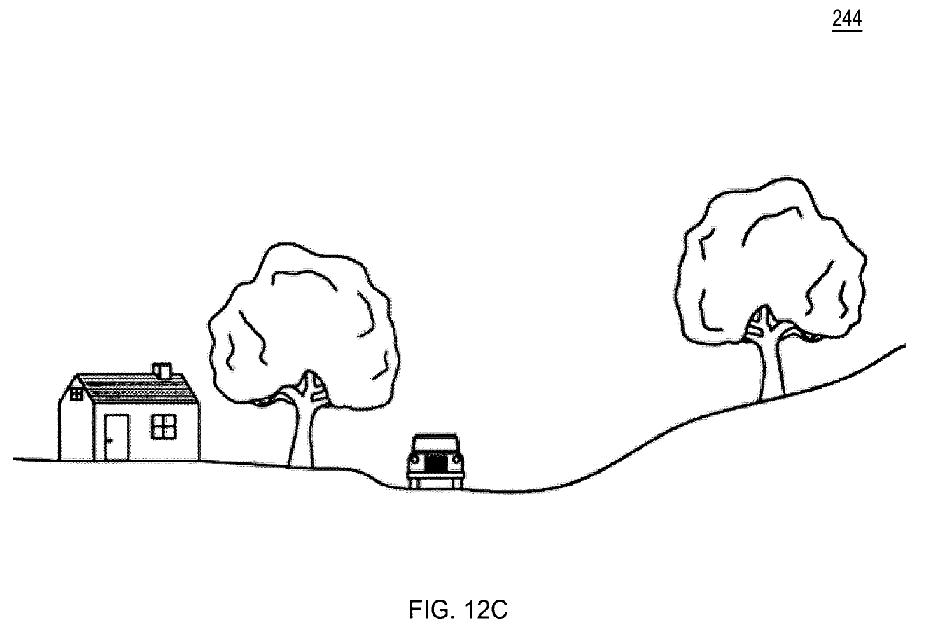

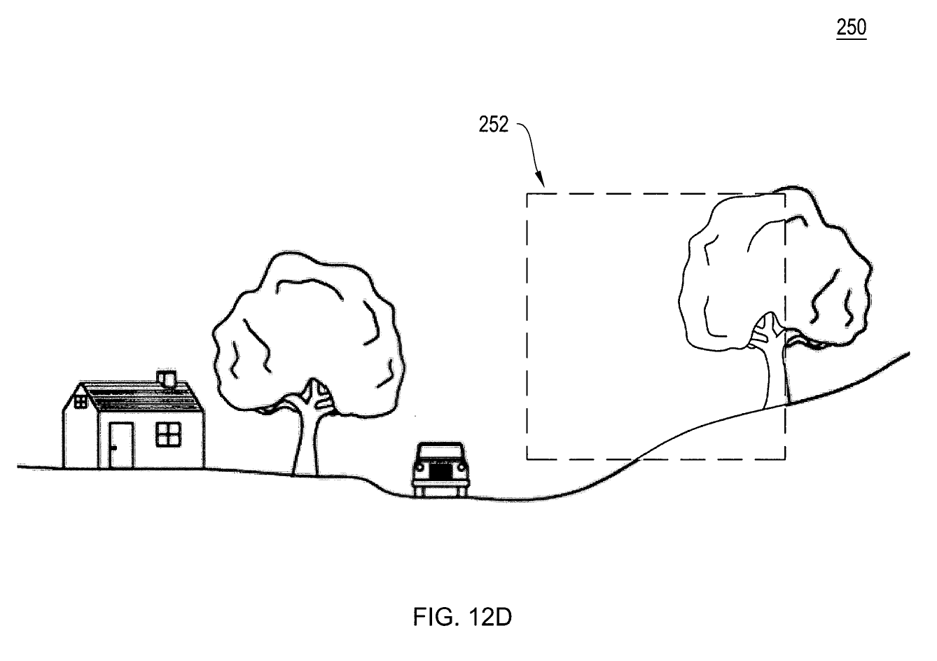

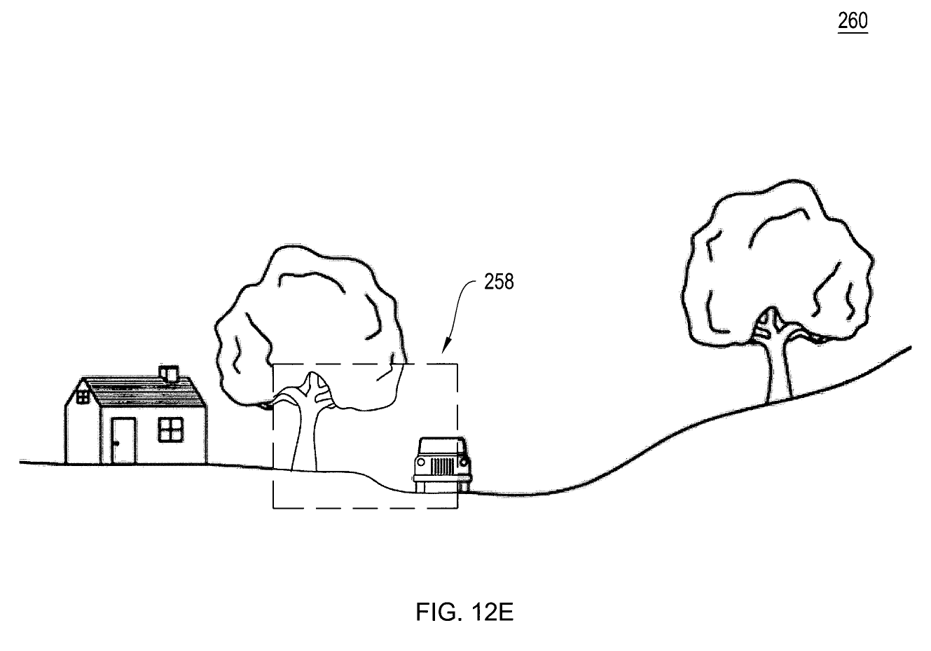

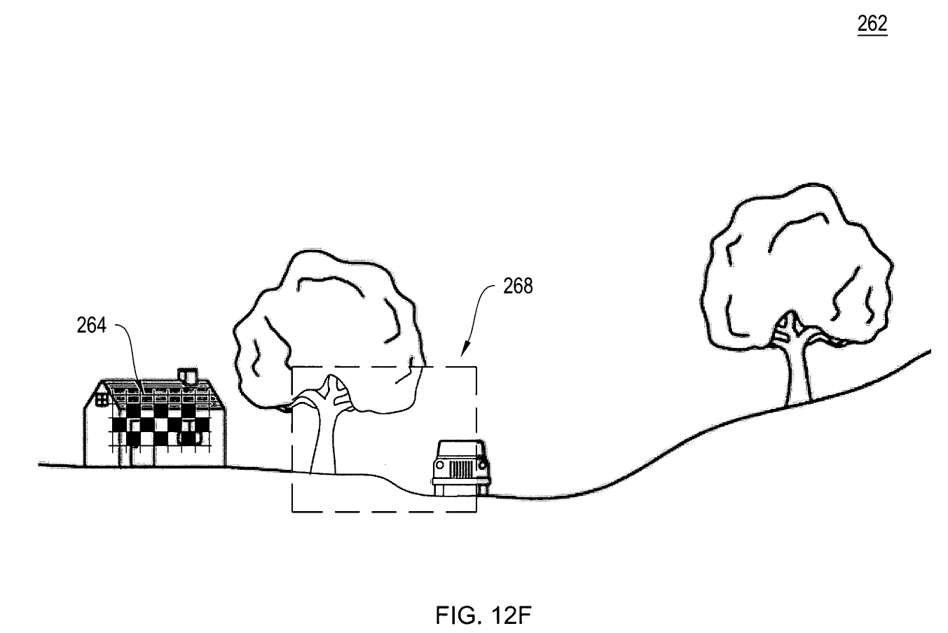

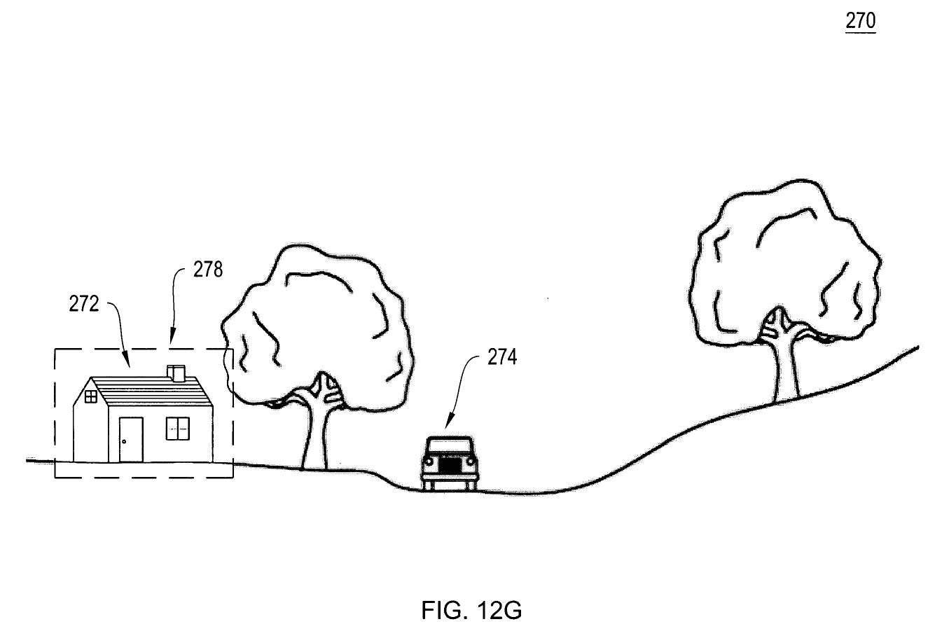

FIG. 12A depicts one example of a high resolution image 240 that may be taken by the any of the systems depicted in FIGS. 11A-11C. The next FIG. 12B depicts a low resolution image 242 of the same scene. This image 242 is blocky as it represents a reduced set of image data being transferred to the user. The image 244 of FIG. 12C depicts the same scene as FIG. 12B, and is derived from the earlier blocky image 242 shown in FIG. 12B by executing a smoothing process that smoothes the image data. According to one embodiment, the blocky, low-resolution image 242 of FIG. 12B is transmitted from the intelligent sensor head to a remote location, and, at the remote location, this image is displayed as a smoothed image 244, shown in FIG. 12C. Both images 242 and 244 contain the same information, but the smoothed image 244 is more readily decipherable by a human user. Moreover, the resolution of the smoothed image 244 is generally sufficient for the human user to be able to understand and identify certain shapes and objects within the scene. Although the image resolution is low and the image 244 lacks detail, the brain tends to fill in the needed detail.

In the human vision system, only a small section (about 5 degrees) in the center of the field of vision (the fovea) is capable of high resolution. Everything outside this section in a viewer's field of view is perceived in a lower resolution. When a viewer's attention is drawn to an object outside the high-resolution fovea, the viewer's eye swivels quickly to focus on the new object of interest, such that the new object lies in the fovea and is perceived at a high resolution and looks sharp.

Additionally, when a viewer “sees” an object, the eye often only transmits enough information for the viewer to recognize the object, and the brain adds in appropriate details from memory. For example, when a viewer sees a face, the brain may “add” eyelashes. In this manner, a smoothed low-resolution image may appear to have more detail than it actually contains, and objects within a smoothed low-resolution image may be easily identified.

Although the smoothing process presents a useful advantage, it is an optional supplemental process, and it is not necessary for the operation of the systems and methods described herein.

The next figure, FIG. 12D, shows an image 250. Either as part of a temporal sequence, in response to user input, or randomly, the system may begin selecting different sections of the image 250 to transmit in high resolution format. This is depicted in FIG. 12D by the high resolution section 252 of the image 250 that appears on the right-hand side of the scene. The next figure, FIG. 12E, shows an image 260, which illustrates the high resolution section 258 being centered on the car and the adjacent tree. The transmitted image 260 has a relatively low resolution for that portion of the image which is not of interest to the user. However, the sensor array that is capturing the image of the car and the adjacent tree can be identified and the image data generated by that sensor can also be identified and transmitted in a high resolution format to the remote location. This provides the composite image 260 depicted in the figure.

FIG. 12F shows an image 262 with a user control box 264 placed over one section of the scene. In this case, the section is a low resolution section. The user may select a section that the user would like to see in high-resolution. The user then may generate a control signal that directs the intelligent sensor to change the section of the image being presented in a high resolution from the section 268 to the section underlying the user control box 264 that is being selected by the user. According to one embodiment, a user control device similar to the user control device 111 of FIG. 14 may be used to shift the user control box 264.

In an alternative embodiment, the system detects motion in the scene, and redirects the high-resolution window to the field of view containing the detected motion.

FIG. 12G depicts the new image 270 which shows a house 272, as is now visible in the high resolution section 278. Moreover, this image 270 also shows the earlier depicted vehicle 274. Although this vehicle 274 is now shown in a low resolution format, the earlier use of the high resolution format allowed a user to identify this object as a car, and once identified, the need to actually present this image in a high resolution format is reduced. The viewer's brain, having already previously recognized the vehicle, fills in appropriate details based on past memories of the appearance of the vehicle. Accordingly, the systems and methods described with reference to FIGS. 10 through 12G provide an intelligent sensor head that has the ability to compress data for the purpose of providing high speed image transmission to a remote user.

Although the intelligent sensor head device, such as devices 230, 233, and 236 shown in FIGS. 11A-11C, may be thrown like a grenade, in another embodiment, the device may have a clamp or other attachment mechanism, and a group of soldiers operating in a hostile urban environment could mount the sensor head on the corner of a building at an intersection they have just passed through. If the intelligent sensor head detects motion in its field of view, it can send the image from a frame within that field of view to the soldiers, with the object which is moving centered within it. For example, if an enemy tank were to come down the road behind the soldiers, the device would send an image of the scene including the tank, alerting the soldiers of the approaching enemy. Such a sensor would make it unnecessary to leave soldiers behind to watch the intersection and the sensor head would be harder for the enemy to detect than a soldier.

In another example in accordance with the invention, a group of soldiers temporarily in a fixed location could set a group of intelligent senor heads around their position to help guard their perimeter. If one of the sensor heads detected motion in its field of view, it would send an image from a frame within that field of view to the soldiers with the moving object centered within it. According to one embodiment, the display alerts the soldiers of a new incoming image or images. If there were objects moving in multiple locations, the sensor heads could display their images sequentially in the display, tile the images, or employ another suitable method for displaying the plurality of images. Optionally, the user may have a handheld remote for controlling the device by wireless controller. A display in the remote may display the data captured and transmitted by the device. The handheld remote may include a digital signal processor for performing image processing functions, such as orienting the image on the display. For example, if the scene data is captured at an angle, such as upside down, the digital signal processor may rotate the image. It may provide a digital zoom effect as well. It will be recognized by those of skill in the art, that although the device may employ low cost, relatively low resolution sensors, the overall pixel count for the device may be quite high given that there are multiple sensors. As such, the zoom effect may allow for significant close up viewing, as the system may digitally zoom on the data captured by a sensor that is dedicated to one FOV within the scene.

In another example in accordance with the invention, the sensor head may be configured such that it may be glued to a wall of a building. Alternatively, the sensor head may be configured so that it may be thrown to the location where the user wishes it to transmit from. So that correct up/down orientation of the image is achieved at the display unit in a way that does not require the user to be precise in the mounting or placement of the sensor head, the sensor head may include a gravity direction sensor that the processor may use to in determining the correct image orientation to send to the display.

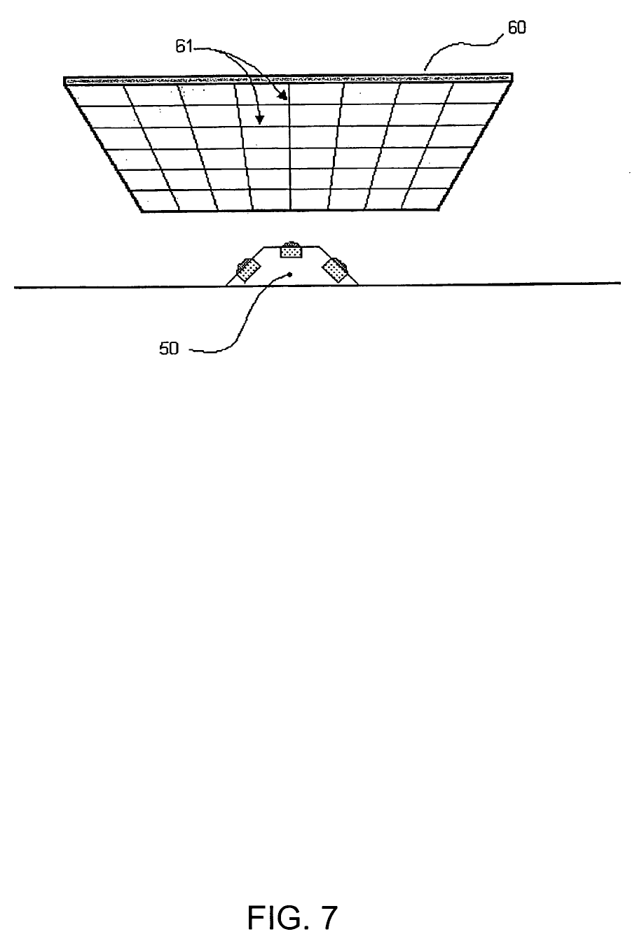

The systems and methods described herein are merely presented as examples of the invention and numerous modifications and additions may be made. For example, the sensors do not need to be on one block, but might be placed around the surface of a vehicle or down the sides of a tunnel or pipe. The more the sensors' fields of view overlap, the more redundancy is built into the system. The calibrating grid may also be a fixed pattern of lights, an LCD or a CRT screen, as depicted in FIGS. 7 and 8. The sensor block may cover more or less than a hemisphere of the environment.

This method allows for non-precision, and thus lower-cost manufacture of the sensor head and a post-manufacturing software calibration of the whole sensor head instead of a precise mechanical calibration for each sensor. If there is to be some relative accuracy in the mounting of each sensor head, then a generic calibration could be burned into the lookup table for the units. This might have applications in situations such as mounting sensors around vehicles so that each individual vehicle does not have to be transported to a calibration facility. It will be understood that compared to a wide-angle lens, the light rays used by multiple 30 sensors that have narrower fields of view are more parallel to the optical axis than light at the edges of a wide-angle len's field of view. Normal rays are easier to focus and thus can get higher resolution with lower cost.

The techniques described herein can be used for pipe (metal or digestive) inspection. If the whole body of the probe “sees,” then you do not need to build in a panning/tilting mechanism. In other embodiments, the device could have sensors mounted around the surface of a large, light ball. With an included gravity (up, down) sensor to orient the device, you could make a traveler that could be bounced across a terrain in the wind and send back video of a 360 degree view. In one practice of manufacturing the systems described herein, the sensors are put in cast Lexan (pressure resistant) and positioned on a deep submersible explorer. For this device, you do not need a heavy, expensive, large and water tight dome for the camera. These inexpensive devices may be used in many applications, such as security and military applications. In one example, a unit may be placed on top of a sub's sail. This may have prevented the recent collision off of Pearl Harbor when a Japanese boat was sunk during a submarine crash surfacing test.

The systems described herein include manufacturing systems that comprise a hemi-spherical dome sized to accommodate a device having a plurality of sensors mounted thereon. As shown in FIG. 13A, a laser, or other light source, may be included that traces a point of light across the interior of the dome. Alternatively, other methods for providing a calibrating grid may be provided including employing a fixed pattern of lights, as well as an LCD or a CRT screen. In any case, a computer coupled to the multiple sensors and to the laser driver determines the location of the point of light and selects a pixel or group of pixels for a sensor, to associate with that location.

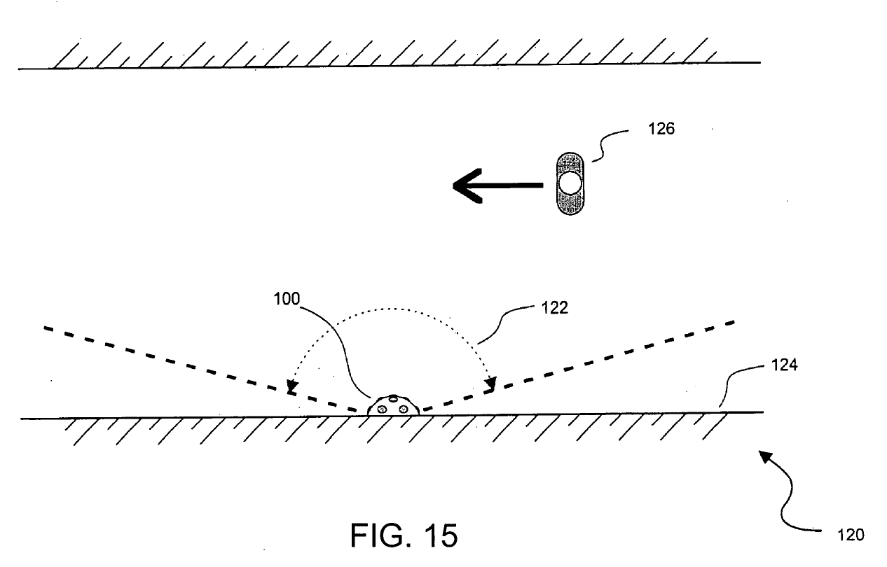

As shown in FIG. 15 in a top view, a sensor head 100 is mounted on the wall of a corridor 120 such that its total field of view 122 covers most of the corridor, and a person 126 walking down the corridor 120 is within the field of view 122.

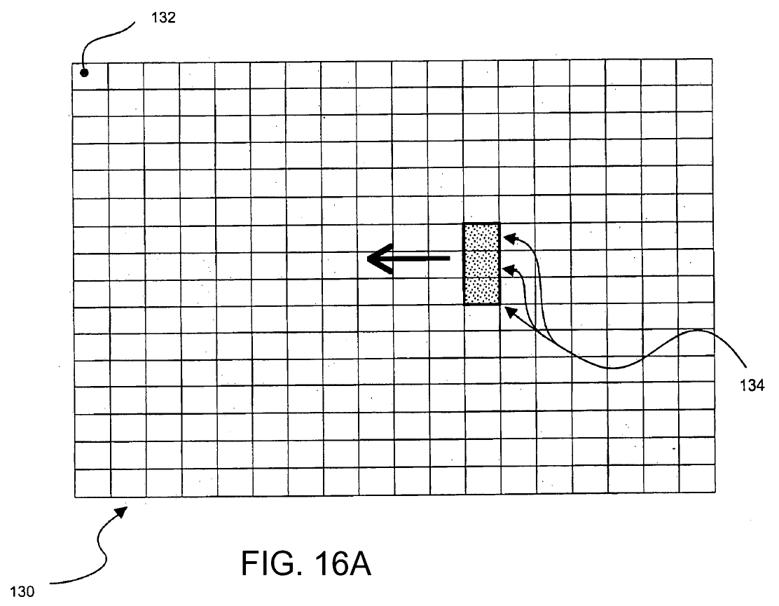

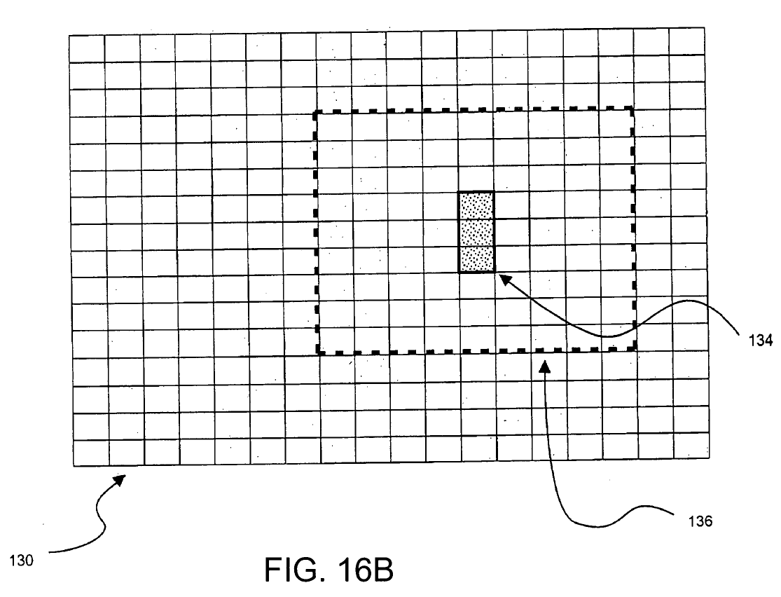

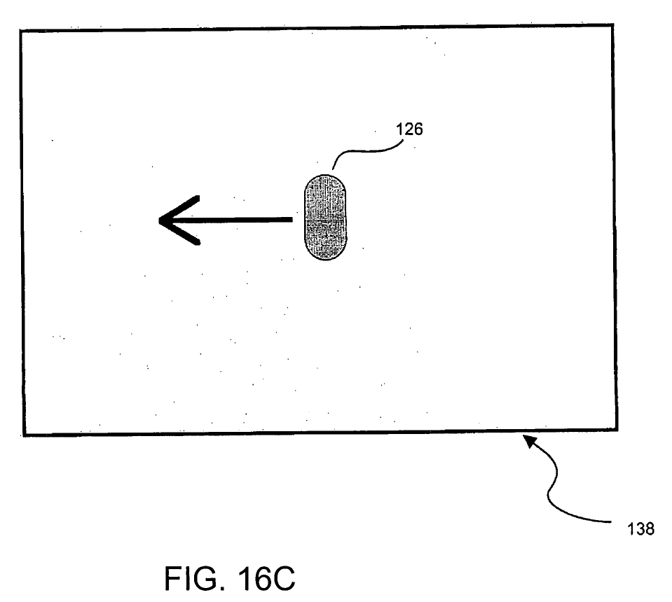

As represented diagrammatically in FIG. 16A, a lookup table 130 is made up of the pixels 132 that comprise the field of view of a device in accordance with the invention. Within these pixels at a certain point in time, a smaller subset of pixels 134 represent an object that is moving within the sensor head's field of view. As shown in FIG. 16B, the sensor head's processor can be programmed to select a frame of view 136 within the sensor head's total field of view 130 which is centered on the pixels 134 that depict a moving object. As shown in FIG. 16C, when this the pixels included in this frame of view are transmitted to the device's display, it will result in an image 138 within which the image of the moving object detected 126 will be centered.

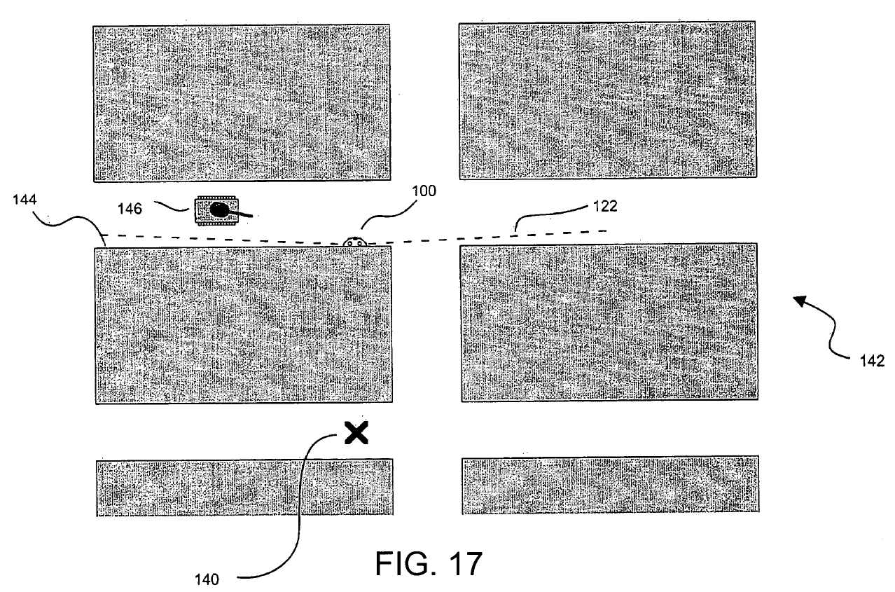

As shown in FIG. 17, if a group of soldiers 140 operating in an urban environment 142 leaves an intelligent sensor head 100 behind them on the wall 144 of a building, mounted such that the head's field of view 122 encompasses the street, then the sensor head can show, via a wireless connection to a display the soldiers retain, when an enemy, such as a tank 146, comes up behind them and constitutes a possible threat.

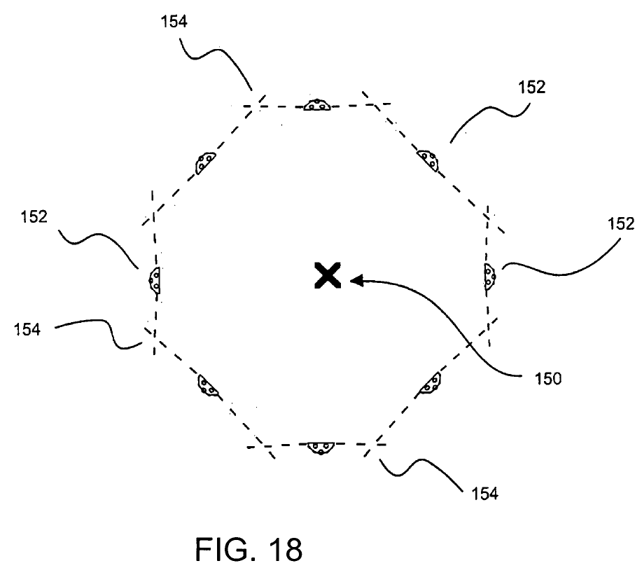

As shown in FIG. 18, a group of soldiers occupying a position 150 may deploy a plurality of intelligent sensor heads 152 around their position such that the fields of view 154 overlap. In this way, the soldiers may more easily maintain surveillance of their position's perimeter to detect threats and possible attacks.

The systems further include sensor devices including a plurality of sensors disposed on a surface of a body and a mechanism for selecting between the sensors to determine which sensor should provide information about data coming from or passing through a particular location. The body may have any shape or size and the shape and size chosen will depend upon the application. Moreover, the body may comprise the body of a device, such as a vehicle, including a car, tank, airplane, submarine or other vehicle. Additionally, the surface may comprise the surface of a collapsible body to thereby provide a periscope that employs solid state sensors to capture images. In these embodiments, the systems may include a calibration system that provides multiple calibration settings for the sensors. Each calibration setting may correspond to a different shape that the surface may attain. Thus the calibration setting for a periscope that is in a collapse position may be different from the calibration setting employed when the periscope is in an extended position and the surface as become elongated so that sensors disposed on the periscope surface are spaced farther apart.

The systems may include sensors selected from the group of image sensors, CCD sensors, infra-red sensors, thermal imaging sensors, acoustic sensors, and magnetic sensors.

As discussed above, these sensor can be realized hardware devices and systems that include software components operating on an embedded processor or on a conventional data processing system such as a Unix workstation. In that embodiment, the software mechanisms can be implemented as a C language computer program, or a computer program written in any high level language including C++, Fortran, Java or Basic. Additionally, in an embodiment where microcontrollers or DSPs are employed, the software systems may be realized as a computer program written in microcode or written in a high level language and compiled down to microcode that can be executed on the platform employed. The development of such image processing systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing (1983). It is noted that DSPs are particularly suited for implementing signal processing functions, including preprocessing functions such as image enhancement through adjustments in contrast, edge definition and brightness. Developing code for the DSP and microcontroller systems follows from principles well known in the art.

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

What is claimed is:

1. An imaging device comprising:
an outer housing,
an inner sensor body,
a plurality of image sensors disposed on the surface of the inner sensor body, each image sensor having a field of view and recording an image in a respective field of view, the image being combinable with one or more other images to form a scene, wherein the scene has a resolution, and
a processor for selectively adjusting the resolution of at least a portion of the scene.

2. The device of claim 1, further comprising a transceiver in connection with the processor, for transmitting image data to a remote location.

3. The device of claim 1, wherein the plurality of image sensors are positioned such that their fields of view overlap.

4. The device of claim 1, further comprising a memory containing a table mapping each of a plurality of image points from the scene to a pixel of at least one image sensor.

5. The device of claim 4, further comprising a display-driver, wherein the display-driver references the table to determine which pixel from which image sensor to use to display a selected section of the scene.

6. The device of claim 1, wherein the plurality of image sensors are positioned to capture at least a hemispherical region within the fields of view of the plurality of image sensors.

7. The device of claim 1, wherein the plurality of image sensors record an image at a high resolution.

8. The device of claim 1, wherein the processor decreases the resolution of the scene.

9. The device of claim 1, wherein the processor decreases the resolution of a portion of the scene.

10. The device of claim 9, wherein the processor selectively decreases the resolution of a portion of the scene that is substantially static.

11. The device of claim 9, wherein a user selects an area of the scene, and the processor decreases the resolution of the unselected portion of the scene.

12. The device of claim 1, further comprising an image multiplexer for receiving the images recorded by the image sensors.

13. The device of claim 12, wherein the image multiplexer merges the images and creates a scene.

14. The device of claim 12, further comprising a memory for storing the images received by the image multiplexer.

15. The device of claim 1, further comprising a memory for storing the images recorded by the sensors.

16. The device of claim 1, wherein the outer housing is robust, such that it remains intact upon impact with a hard surface.

17. The device of claim 1, wherein the processor selectively adjusts the resolution to allow for real-time transmission of image data.

18. The device according to claim 1, wherein the outer housing comprises a housing dimensionally adapted to fit within the hand of a person.

19. The device according to claim 1, further comprising a mount for mounting the housing to a structure.

20. The device of claim 8, wherein the processor includes means for decreasing the resolution of portions of the image to provide a user sufficient resolution for situational awareness.

21. The device of claim 1, further comprising a grid pattern disposed within the fields of view of at least two sensors for allowing said at least two sensors to capture an image of the grid pattern appearing in its respective field of view.

22. The device of claim 21, further comprising a calibration mechanism for processing said captured images to identify overlapping regions within the fields of view of a plurality of sensors and for generating a look up table correlating pixels in a panoramic image with pixels in the plurality of sensors.

23. An imaging device comprising:
an outer housing,
an inner sensor body,
at least one image sensor disposed on the surface of the inner sensor body, the image sensor having a field of view and recording an image in the field of view, wherein the image has a resolution, and
a processor for selectively adjusting the resolution of at least a portion of the image.

24. The device of claim 23, wherein the image sensor records an image at a high resolution.

25. The device of claim 23, wherein the processor decreases the resolution of the image.

26. The device of claim 23, wherein the processor decreases the resolution of a portion of the image.

27. The device of claim 26, wherein the processor selectively decreases the resolution of a portion of the image that is substantially static.

28. The device of claim 26, wherein a user selects an area of the image, and the processor decreases the resolution of the unselected portion of the image.

29. The device of claim 23, wherein the processor selectively adjusts the resolution to allow for real-time transmission of image data.

30. The device of claim 29, wherein the outer housing is robust, such that it remains intact upon impact with a hard surface.
